(19) United States
(12) Patent Application Publication
(10) Pub. No.: US 2010/0161803 A1
(43) Pub. Date: Jun. 24, 2010

(54) Java Enterprise Resource Management System and Method

(76) Inventors: Johney Tsai, Irvine, CA (US); David Strong, Laguna, CA (US)

Correspondence Address: UNISYS CORPORATION, UNISYS WAY, MAIL STATION: E8-114, BLUE BELL, PA, 19424, US

(21) Appl. No.: 12/347,006

(22) Filed: Dec. 31, 2008

Related U.S. Application Data
(63) Continuation of application No. 12/340,844, filed on Dec. 22, 2008.

(51) Int. Cl. G06F 15/173

(52) U.S. Cl. 709/226; 715/234

(57) ABSTRACT

A Java enterprise resource management (JERM) system and method are provided that allow both timing metrics and call metrics to be monitored and gathered in real-time, and which can cause appropriate actions to be taken in real-time. The JERM system provides a level of granularity with respect to the monitoring of methods triggered during a transaction that is equivalent to or better than that which is currently provided in the aforementioned known call-analysis resource management systems. In addition, the JERM system also provides information associated with the timing of hops that occur between servers, and between and within applications, during a transaction. Because all of this information is obtained in real-time, the JERM system is able to respond in real-time to cause resources to be scaled in or scaled out in a way that provides improved efficiency and productivity, and that enables the enterprise to quickly recover from resource failures.

### CROSS-REFERENCE TO RELATED APPLICATIONS

This application is a continuation application of U.S. nonprovisional application Ser. No. 12/340,844, filed on Dec. 22, 2008, entitled “JAVA ENTERPRISE RESOURCE MANAGEMENT SYSTEM AND METHOD”, the benefit of the filing date to which priority is hereby claimed, and which is hereby incorporated by reference herein in its entirety.

### TECHNICAL FIELD

The instant disclosure relates to resource management systems and methods.

### BACKGROUND

Resource management systems (RMSs) monitor events and transactions that occur in computer resources of an enterprise and take actions to improve the performance and accountability of the enterprise. The computer resources typically include different types of servers, databases, telecommunications equipment, and other devices that perform particular functions in the enterprise. The computer resources are typically located in a data center. The servers that are found in a typical enterprise data center vary in type and include web servers, application servers, email servers, proxy servers, domain name system (DNS) servers, and other types of servers. By monitoring transactions as they occur in the enterprise, a RMS can determine whether resources are operating properly and efficiently, and if not, take actions to allocate or re-purpose resources in a way that increases the efficiency and productivity of the enterprise, and/or that enables a recovery to be made in the event that a resource failure has occurred.

A typical RMS monitors transactions being performed by computer resources of the enterprise to obtain measurements relating to their performance. These measurements are commonly referred to as metrics. A typical RMS includes a resource management server that runs a resource management software program that is designed to obtain and analyze particular metrics. The metrics that are monitored and acted upon by a RMS can typically be varied by making changes to the resource management software program. System-level metrics that are typically monitored include central processing unit (CPU) utilization, random access memory (RAM) usage, disk input/output (I/O) performance, and network I/O performance. Application-level metrics that are typically monitored include response time metrics, Structured Query Language (SQL) calls metrics, and Enterprise JavaBeans (EJB) calls metrics.

An example of the manner in which the CPU usage metric is monitored and acted upon by a typical RMS is as follows. For this example, it will be assumed that the enterprise includes a farm of application servers that perform operations associated with accounts payable tasks and a farm of application servers that perform operations associated with accounts receivable tasks. The RMS monitors transactions being performed on these servers and determines that the loads on the CPUs of the accounts payable servers are relatively low and that the loads on the CPU of the accounts receivable servers are relatively high. The relatively high CPU loads on the accounts receivable servers may result in the accounts receivable tasks being performed relatively slowly. The relatively low CPU loads on the accounts payable servers indicate that the accounts payable servers are being under-utilized. In this scenario, a typical RMS will determine that the loads on the CPUs of the accounts receivable servers are too high and that the accounts payable servers are being under-utilized. In response to this determination, the RMS will re-allocate the processing loads among the servers by re-purposing one or more of the accounts payable servers to be used in performing some share of the accounts receivable tasks.

An example of the manner in which an application-level metric is monitored and acted upon by a typical RMS is as follows. For this example, it is assumed that the enterprise is an E-commerce enterprise in which goods or services are sold and funds are transferred digitally online over a public network such as the Internet or over some private network to which users can obtain access. The checkout process is controlled by an application server that executes a software program that performs tasks associated with the checkout process. A different application server executes a software program that performs a verification process if, during the checkout process, the checkout application server detects that the user has entered a discount code. The user places items in an online shopping cart and attempts to checkout by clicking on a submit button. The website, however, appears not to be responding. Consequently, the user becomes frustrated and decides to purchase the items on a different website. At a later point in time, the RMS traces the transaction and finds that the delay was caused due to verification process taking a very long time to verify the discount code. After further analysis, the RMS determines that a table that is used by the verification software program is missing an index, and that the missing index caused a delay in the verification process. The RMS then causes the index to be inserted into the table to prevent delays in the future.

RMSs generally may be classified as being one of two types, namely, (1) response-time RMSs or (2) call-analysis RMSs. In response-time RMSs, the only metrics that are monitored and analyzed are timing metrics. One timing metric that is often used measures the amount of time that passes between an instant in time when the user clicks a submit button on his or her web browser to an instant in time when the corresponding web server receives the submission. Another timing metric that is often used measures the amount of time that passes between an instant in time when the corresponding web server receives the submission to an instant in time when the corresponding application server receives the submission. Another timing metric that is often used measures the amount of time that passes from an instant in time when the corresponding application server receives the submission to an instant in time when the corresponding database server receives the submission. In other words, response-time RMSs monitor metrics relating to the timing of hops from one server to the next when servicing a transaction. However, run-time RMSs do not provide information relating to the underlying methods that are performed when servicing a transaction. Rather, the underlying methods are essentially “black boxes” in that the details associated with the performance of the methods are not provided.

In call-analysis RMSs, the metrics that are monitored and analyzed relate to measurements associated with the performance of methods that have been called during a transaction. These call metrics provide information about each method that has been called and about which method triggered any other method during the transaction. These types of RMSs are not used to monitor and manage resources in real-time, but are used to debug enterprise resources offline (i.e., in non-real-time). The reason for this is that monitoring call metrics in real-time will typically slow down the transaction, which degrades the experience for the user. Consequently, it is seen as impractical to implement call-analysis RMSs that monitor and analyze call metrics in real-time.

### SUMMARY

A Java enterprise resource management (JERM) system and method are provided. In accordance with an embodiment, the JERM system comprises at least a first input/output (I/O) communications port and one or more processing devices located on the server side of a network. The I/O communications port is configured to function as a server-side end of a first communications socket to receive a first serial byte stream output from a second end of the communications socket via an I/O port of a production server located on a client side of the network. The first byte stream includes information relating to at least a first metric that has been monitored and gathered by a production server located on a client side of the network during performance of one or more transactions by the production server. The one or more processing devices are configured to analyze the byte stream output from the second end of the communications socket to decide whether at least a first rule is to be applied to the first metric. If a decision is made that at least a first rule is to be applied to the first metric, the one or more processing devices decide whether the first metric is in compliance with at least the first rule and produces a decision regarding compliance. The one or more processing devices analyze the decision regarding compliance and make a decision as to whether at least one physical instance, at least one virtual instance, or a combination of one or more physical and virtual instances needs to be scaled out or scaled in on the client side.

The JERM method, in accordance with an embodiment, comprises receiving at a server-side end of a communications socket a serial byte stream communicated over the socket from a client-side end of the socket to the server-side end of the socket. The serial byte stream includes at least a first metric monitored and gathered by a production server located on a client side of a network during performance of one or more transactions by the production server. The method further includes, in one or more processing devices located on the server side of the network, deserializing the serial byte stream received at the server-side end of the communications socket and analyzing the deserialized byte stream to decide whether at least a first rule is to be applied to the first metric. The method further includes, in the one or more processing devices, if a decision is made that at least a first rule is to be applied to the first metric, deciding whether the first metric is in compliance with the first rule and producing a decision regarding compliance. The method further includes, in the one or more processing devices, analyzing the decision regarding compliance and making a decision as to whether at least one physical instance, at least one virtual instance, or a combination of one or more physical and virtual instances needs to be scaled out or scaled in on the client side.

In accordance with another embodiment, a computer-readable medium (CRM) is provided having instructions stored thereon for performing a JERM method on a server side of a network. The instructions that are stored on the CRM comprises at least a first deserializer computer code portion, at least a first rules management computer code portion, and at least a first actions manager computer code portion. When the first deserializer computer code portion runs on a JERM management server located on the server side of the network, the first deserializer computer code portion receives a serial byte stream corresponding to at least a first metric communicated over a communications socket from a production server located on a client side of the network and deserializes the received byte stream to produce a deserialized byte stream containing information relating to the first metric. The first metric or metrics correspond to one or more metrics monitored and gathered by the production server while a transaction is performed by the production server. When the first rules management computer code portion runs on the JERM management server, the first rules management computer code portion decides whether a rule exists that is associated with the first metric or metrics, and if so, applies the associated rule to the deserialized byte stream and produces a decision as to whether the first metric is in compliance with the associated rule. When the first actions manager computer code portion runs on the JERM management server, the first actions manager computer code portion determines, based on the decision as to whether the first metric is in compliance with an associated rule, whether at least one action needs to be taken. If the first actions manager computer code portion determines that at least one action needs to be taken, the first actions manager computer code portion causes one or more commands to be sent to the client side of the network to cause one or more production servers located on the client side of the network to perform one or more tasks consistent with said one or more commands.

These and other features and advantages will become apparent from the following description, drawings and claims.

### BRIEF DESCRIPTION OF THE DRAWINGS

FIG. 1 illustrates a block diagram of the JERM system in accordance with an embodiment.

FIG. 2 illustrates a block diagram of the JERM system in accordance with another illustrative embodiment.

FIG. 3 illustrates a flowchart that represents a method in accordance with an illustrative embodiment for performing Java enterprise resource management on the client side.

FIG. 4 illustrates a flowchart that represents a method in accordance with an illustrative embodiment for performing Java enterprise resource management on the server side.

### DETAILED DESCRIPTION

In accordance with an embodiment, a Java enterprise resource management (JERM) system is provided that combines attributes of run-time RMSs and call-analysis RMSs to allow both timing metrics and call metrics to be monitored in real-time, and which can cause appropriate actions to be taken in real-time. The JERM system provides a level of granularity with respect to the monitoring of methods that are triggered during a transaction that is equivalent to or better than that which is currently provided in the aforementioned known call-analysis RMSs. In addition, the JERM system also provides information associated with the timing of hops that occur between servers, and between and within applications, during a transaction. Because all of this information is obtained in real-time, the JERM system is able to respond in real-time, or near real-time, to cause resources to be allocated or re-allocated in a way that provides improved efficiency and productivity, and in a manner that enables the enterprise to quickly recover from resource failures. In addition, the JERM system is a scalable solution that can be widely implemented with relative ease and that can be varied with relative ease in order to meet a wide variety of implementation needs. The following description of the drawings describes illustrative embodiments of the JERM system and method.

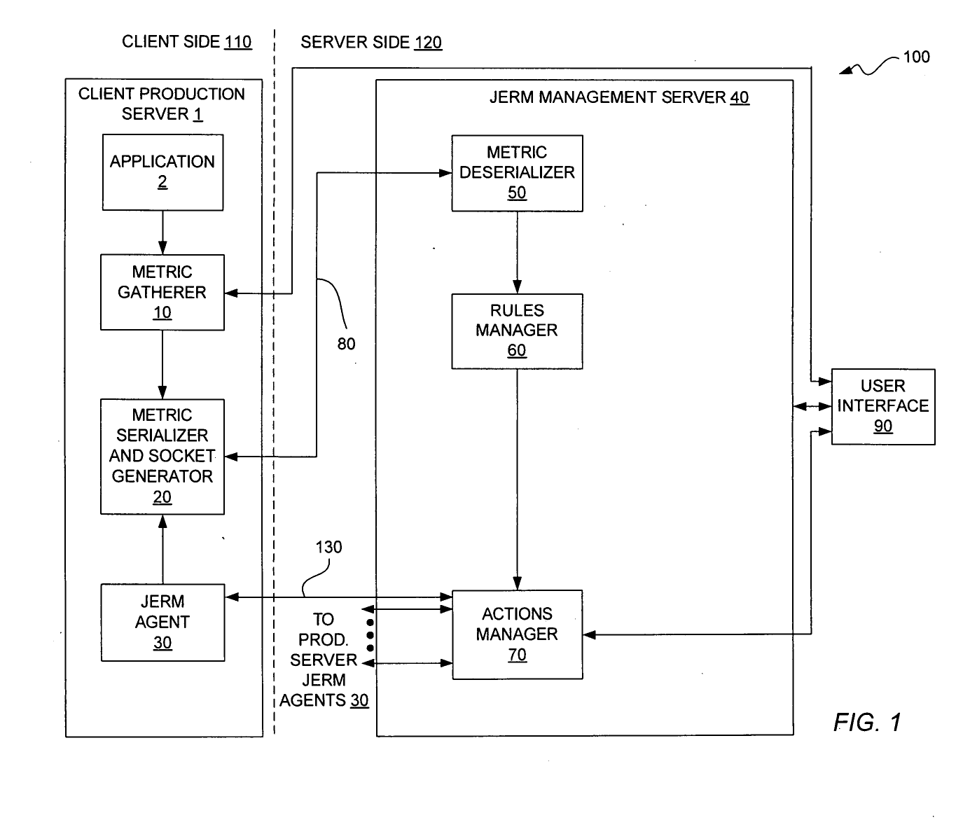

FIG. 1 is a block diagram illustrating the JERM system 100 in accordance with an embodiment. The JERM system 100 comprises a client side 110 and a server side 120. On the client side 110, a client Production Server 1 runs various computer software programs, including, but not limited to, an application computer software program 2, a metrics gathering computer software program 10, a metrics serializer and socket generator computer software program 20, and a JERM agent computer software program 30. The Production Server 1 is typically one of many servers located on the client side 110. The Production Server 1 and other servers (not shown) are typically located in a data center (not shown) of the enterprise (not shown). For example, the Production Server 1 may be one of several servers of a server farm, or cluster, that perform similar processing operations, or applications. The application that is performed by each server is controlled by the application computer software program that is being run on the server. In the case of a farm of servers, each server of the same farm may run the same application software program and may have the same operating system (OS) and hardware. A data center may have multiple server farms, with each farm being dedicated to a particular purpose.

The application program 2 that is run by the Production Server 1 may be virtually any Java Enterprise Edition (Java EE) program that performs one or more methods associated with a transaction, or all methods associated with a transaction. During run-time while the application program 2 is being executed, the metrics gathering program 10 monitors the execution of the application program 2 and gathers certain metrics. The metrics that are gathered depend on the manner in which metrics gathering program 10 is configured. A user interface (UI) 90 is capable of accessing the production server 1 to modify the configuration of the metrics gathering program 10 in order to add, modify or remove metrics. Typical system-level metrics that may be gathered include CPU utilization, RAM usage, disk I/O performance, and network I/O performance. Typical application-level metrics that may be gathered include response time metrics, SQL call metrics, and EJB call metrics. It should be noted, however, that the disclosed system and method are not limited with respect to the type or number of metrics that may be gathered by the metrics gathering program 10.

In the illustrated embodiment, metrics that are gathered by the metrics gathering program 10 are provided to the metrics serializer and socket generator (MSSG) software program 20. The MSSG program 20 serializes each metric into a serial byte stream and generates a communications socket that will be used to communicate the serial byte stream to the JERM Management Server 40 located on the server side 120 of the JERM system 100. The serial byte stream is then transmitted over the socket 80 to the JERM Management Server 40. The socket 80 is typically a Transmission Control Protocol/Internet Protocol (“TCP/IP”) socket that provides a bidirectional communications link between an I/O port of the Production Server 1 and an I/O port of the JERM Management Server 40.

In the illustrated embodiment, the JERM Management Server 40 runs various computer software programs, including, but not limited to, a metrics deserializer computer software program 50, a rules manager computer software program 60, and an actions manager computer software program 70. The metrics deserializer program 50 receives the serial byte stream communicated via the socket 80 and performs a deserialization algorithm that deserializes the serial byte stream to produce a deserialized metric. The deserialized metric comprises parallel bits or bytes of data that represent the metric gathered on the client side 110 by the metrics gathering program 10. The deserialized metric is then received by the rules manager program 60. The rules manager program 60 analyzes the deserialized metric and determines whether a rule exists that is to be applied to the deserialized metric. If a determination is made by the rules manager program 60 that such a rule exists, the rules manager program 60 applies the rule to the deserialized metric and makes a decision based on the application of the rule. The rules manager program 60 then sends the decision to the actions manager program 70. The actions manager program 70 analyzes the decision and decides if one or more actions are to be taken. If so, the actions manager program 70 causes one or more actions to be taken by sending a command to the Production Server 1 on the client side 110, or to some other server (not shown) on the client side 110. As stated above, there may be multiple instances of the Production Server 1 on the client side 110, so the action that is taken may be directed at a different server (not shown) on the client side 110.

In accordance with an embodiment, each Production Server 1 on the client side 110 runs the JERM agent software program 30. For ease of illustration, only a single Production Server 1 is shown in FIG. 1. The JERM agent program 30 is configured to detect if a command has been sent from the actions manager program 70 and to take whatever action is identified by the command. The actions include scaling out one or more physical and/or virtual instances and scaling in one or more physical and/or virtual instances. The commands that are sent from the actions manager program 70 to one or more of the JERM agent programs 30 of one or more of the Production Servers 1 are sent over a communications link 130, which may be an Internet socket connection or some other type of communications link.

An example of an action that scales out another physical instance is an action that causes another Production Server 1 to be brought online or to be re-purposed. By way of example, without limitation, in the scenario given above in which the processing loads on the CPUs of the accounts receivable servers are too high, the rules manager program 60 may process the respective CPU load metrics for the respective accounts receivable servers, which correspond to Production Servers 1, and decide that the CPU loads are above a threshold limit defined by the associated rule. The rules manager program 60 will then send this decision to the actions manager program 70. The actions manager program 70 will then send commands to one or more JERM agent programs 30 running of one or more accounts payable servers, which also correspond to Production Servers 1, instructing the JERM agent programs 30 to cause their respective servers to process a portion of the accounts receivable processing loads. The actions manager program 70 also sends commands to one or more JERM agent programs 30 of one or more of the accounts receivable servers instructing those agents 30 to cause their respective accounts receivable servers to offload a portion of their respective accounts receivable processing loads to the accounts payable servers.

An example where the action taken by the actions manager program 70 is the scaling out of one or more virtual instances is as follows. Assuming that the application program 2 running on the Production Server 1 is a particular application program, such as the checkout application program described above, the actions manager program 70 may send a command to the JERM agent program 30 that instructs the JERM agent program 30 to cause the Production Server 1 to invoke another instance of the checkout application program so that there are now two instances of the checkout application program running on the Production Server 1.

In the same way that the actions manager program 70 scales out additional physical and virtual instances, the actions manager program 70 can reduce the number and types of physical and virtual instances that are scaled out at any given time. For example, if the rules manager program 60 determines that the CPU loads on a farm of accounts payable servers are low (i.e., below a threshold limit), indicating that the serves are being under-utilized, the actions manager program 70 may cause the processing loads on one or more of the accounts payable Production Servers 1 of the farm to be offloaded onto one or more of the other accounts payable Production Servers 1 of the farm to enable the Production Servers 1 from which the loads have been offloaded to be turn off or re-purposed. Likewise, the number of virtual instances that are running can be reduced based on decisions that are made by the rules manager program 60. For example, if the Production Server 1 is running multiple Java virtual machines (JVMs), the actions manager 70 may reduce the number of JVMs that are running on the Production Server 1. The specific embodiments described above are intended to be exemplary, and the disclosed system and method should not be interpreted as being limiting to these embodiments or the descriptions thereof.

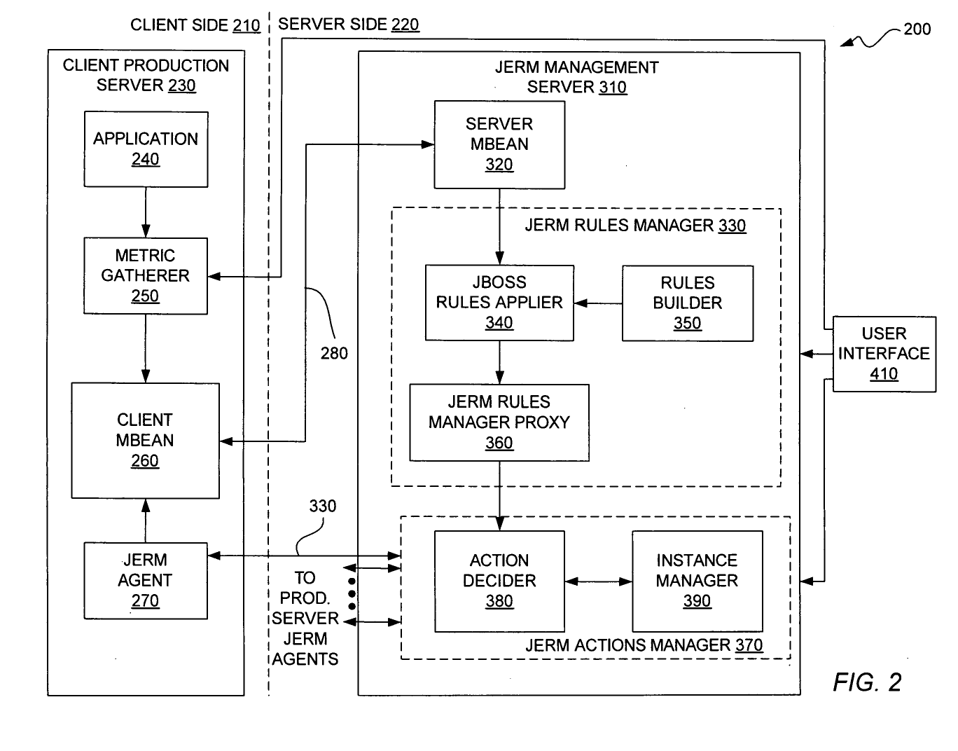

FIG. 2 is a block diagram of the JERM system 200 in accordance with another illustrative embodiment. The JERM system 200 of FIG. 2 includes some of the same components as those of the JERM system 100 shown in FIG. 1, but also includes some additional components and functionality not included in the JERM system 100 of FIG. 1. For example, like the JERM system 100 of FIG. 1, the JERM system 200 of FIG. 2 has a client side 210 and a server side 220, which have a Production Server 230 and a JERM Management Server 310, respectively. On the client side 210, the Production Server 230 runs various computer software programs, including, but not limited to, an application computer software program 240, a metrics gathering computer software program 250, a client Managed Bean (MBean) computer software program 260, and a JERM agent computer software program 270. The Production Server 230 is typically one of many servers located on the client side 210. The Production Server 230 and other servers (not shown) are typically located in a data center (not shown) of the enterprise (not shown). Thus, the JERM Management Server 310 typically communicates with and manages multiple servers, some of which are substantially identical to (e.g., additional instances of) the Production Server 230 running application program 240 and some of which are different from the Production Server 230 and perform functions that are different from those performed by the Production Server 230.

The application program 240 may be any program that performs one or more methods associated with a transaction, or that performs all methods associated with a transaction. During run-time while the application program 240 is being executed, the metrics gathering program 250 monitors the execution of the application program 240 and gathers certain metrics. The metrics that are gathered depend on the manner in which the metrics gathering program 250 is configured. In accordance with this embodiment, the metrics gathering program 250 gathers metrics by aspecting JBoss interceptors. JBoss is an application server program for use with Java EE and EJBs. An EJB is an architecture for creating program components written in the Java programming language that run on the server in a client/server model. An interceptor, as that term is used herein, is a programming construct that is inserted between a method and an invoker of the method, i.e., between the caller and the callee. The metrics gathering program 250 injects, or aspects, JBoss interceptors into the application program 240. The JBoss interceptors are configured such that, when the application program 240 runs at run-time, timing metrics and call metrics are gathered by the interceptors. This feature enables the metrics to be collected in real-time without significantly affecting the performance of the application program 240.

A UI 410, which is typically a graphical UI (GUI) enables a user to interact with the metrics gatherer program 250 to add, modify or remove metrics so that the user can easily change the types of metrics that are being monitored and gathered. Typical system-level metrics that may be gathered include CPU utilization, RAM usage, disk I/O performance, and network I/O performance. Typical application-level metrics that may be gathered include response time metrics, SQL call metrics, and EJB call metrics. It should be noted, however, that the disclosed system and method are not limited with respect to the type or number of metrics that may be gathered by the metrics gathering program 250.

The client MBean program 260 receives the metrics gathered by the JBoss interceptors of the metrics gathering program 250 and performs a serialization algorithm that converts the metrics into a serial byte stream. An MBean is an object in the Java programming language that is used to manage applications, services or devices, depending on the class of the MBean that is used. The client MBean program 260 also sets up an Internet socket 280 for the purpose of communicating the serial byte stream from the client side 210 to the server side 220. The metrics are typically sent from the client side 210 to the server side 220 at the end of a transaction that is performed by the application program 240.

The server side 220 includes a JERM Management Server 310, which is configured to run a server MBean computer software program 320, a JERM rules manager computer software program 330, and a JERM actions manager computer software program 370. The server MBean program 320 communicates with the client MBean program 260 via the socket 280 to receive the serial byte stream. The server MBean program 320 performs a deserialization algorithm that deserializes the serial byte stream to convert the byte stream into parallel bits or bytes of data representing the metrics. The JERM rules manager program 330 analyzes the deserialized metric and determines whether a rule exists that is to be applied to the deserialized metric. If a determination is made by the rules manager program 330 that such a rule exists, the rules manager program 330 applies the rule to the deserialized metric and makes a decision based on the application of the rule. The rules manager program 330 then sends the decision to a JERM rules manager proxy computer software program 360, which formats the decision into a web service request and sends the web service request to the JERM actions manager program 370.

The JERM actions manager program 370 is typically implemented as a web service that is requested by the JERM rules manager proxy program 360. The JERM actions manager program 370 includes an action decider computer program 380 and an instance manager program 390. The actions decider program 380 analyzes the request and decides if one or more actions are to be taken. If so, the actions decider program 380 sends instructions to the instance manager program 390 indicating one or more actions that need to be taken. In some embodiments, the instance manager program 390 has knowledge of all of the physical and virtual instances that are currently running on the client side 210, and therefore can make the ultimate decision on the type and number of physical and/or virtual instances that are to be scaled out and/or scaled in on the client side 210. Based on the decision that is made by the instance manager program 390, the JERM actions manager program sends instructions via one or more of the communications links 330 to one or more corresponding JERM agent programs 270 of one or more of the Production Servers 230 on the client side 210.

Each Production Server 230 on the client side 210 runs a JERM agent program 270. For ease of illustration, only a single Production Server 230 is shown in FIG. 2. The JERM agent program 270 is configured to detect if a command has been sent from the actions manager 370 and to take whatever action is identified by the command. The actions include scaling out another physical and/or virtual instance and scaling in one or more physical and/or virtual instances. The communications link 330 may be a TCP/IP socket connection or other type of communications link. The types of actions that may be taken include, without limitation, those actions described above with reference to FIG. 1.

The UI 410 also connects to the JERM rules manager program 330 and to the JERM actions manager program 370. In accordance with this embodiment, the JERM rules manager program 330 is actually a combination of multiple programs that operate in conjunction with one another to perform various tasks. One of these programs is a rules builder program 350. A user interacts via the UI 410 with the rules builder program 350 to cause rules to be added, modified or removed from a rules database, which is typically part of the rules builder program 350, but may be external to the rules builder program 350. This feature allows a user to easily modify the rules that are applied by the JBoss rules applier program 340.

The connection between the UI 410 and the JERM actions manager program 370 enables a user to add, modify or remove the types of actions that the JERM actions manager 370 will cause to be taken. This feature facilitates the scalability of the JERM system 200. Over time, changes will typically be made to the client side 210. For example, additional resources (e.g., servers, application programs and/or devices) may be added to the client side 210 as the enterprise grows. Also, new resources may be substituted for older resources, for example, as resources wear out or better performing resources become available. Through interaction between the UI 410 and the JERM actions manager program 370, changes can be made to the instance manager program 390 to reflect changes that are made to the client side 210. By way of example, without limitation, the instance manager program 390 typically will maintain one or more lists of (1) the total resources by type, network address and purpose that are employed on the client side 210, (2) the types, purposes and addresses of resources that are available at any given time, and (3) the types, purposes and addresses of resources that are in use at any given time. As resource changes are made on the client side 210, a user can update the lists maintained by the instance manager program 390 to reflect these changes.

Without limitation, some of the important features that enable the JERM system 200 to provide improved performance over known RMSs of the type described above include: (1) the use of interceptors by the metrics gatherer program 250 to gather metrics without affecting the performance of a transaction while it is being performed by the application program 240: (2) the use of the client MBean program 260 to convert the metrics into serial byte streams and send the serial byte stream over a TCP/IP socket 280 to the server side 220; and (3) the use of the server MBean program 320 to deserialize the byte stream received over the socket 280. These features enable the JERM rules manager program 330 to quickly apply rules to the metrics as they are gathered in real-time and enable the JERM actions manager 370 to take actions in real-time, or near real-time, to allocate and/or re-purpose resources on the client side 210.

Another feature of some embodiments is that the metrics gatherer program 250 can be easily modified by a user, e.g., via the UI 410. Such modifications enable the user to update and/or change the types of metrics that are being monitored by the metrics gatherer program 250. This feature provides great flexibility with respect to the manner in which resources are monitored, which, in turn, provides great flexibility in deciding actions that need to be taken to improve performance on the client side 210 and taking those actions.

Another feature present in some embodiments is that certain functionality on the client side 210 and on the server side 220 is implemented with a client-side work chain and with a server-side work chain, respectively. For example, in one embodiment, the client-side work chain comprises only the functionality that performs the serialization and socket generation programs that are wrapped in the client MBean 260. In one embodiment, the server-side work chain comprises the functionality for performing the socket communication and deserialization algorithms are wrapped in the server MBean 320, and the functionality for performing the algorithms of the rules manager program 330. These work chains operate like assembly lines, and parts of the work chains can be removed or altered to change the behavior of the JERM system 200 without affecting the behavior of the application program 240. Essentially, the work chains are configured in XML, and therefore, changes can be made to the work chains in XML, which tends to be an easier task than modifying programs written in other types of languages which are tightly coupled.

For example, the following XML code corresponds to the client-side work chain in accordance with the embodiment referred to above in which the client-side work chain only comprises the functionality corresponding to the serialization and socket generation programs that are wrapped in the client MBean 260.

```
<?xml version=“1.0” encoding=“UTF-8” ?>
<production>
    <!-- unique name to identify this production server -->
    <identification>
        <name>Prod1</name>
    </identification>
    <!-- information describing where the JERM Management
    server is -->
    <bindings>
        <serverAddress>localhost</serverAddress>
        <serverPort>9090</serverPort>
    </bindings>
    <!-- min/max number of threads to perform network io -->
    <workers>
        <min>10</min>
        <max>20</max>
    </workers>
    <!-- min/max number of connections in the connection pool-->
    <connections>
        <min>32</min>
        <max>64</max>
        <refill>16</refill>
    </connections>
    <!--
        name = class to instantiate
        minThreads = minimum number of workers threads
        to service queue
        maxThreads = maximum number of workers threads
        to service queue
        addTimeout = maximum time in ms to wait before timing
        out trying to
            produce to the queue
        -->
    <chain>
        <queue>
            <name>com.unisys.jerm.queue.client.
            SerializerQueue</name>
            <minThreads>16</minThreads>
            <maxThreads>32</maxThreads>
            <addTimeout>200</addTimeout>
        </queue>
</production>
```

The client-side work chain can be easily modified to include an audit algorithm that logs information to a remote log identifying any processes that have interacted with the data being processed through the work chain. Such a modification may be made by adding the following audit <queue> fragment to the XML code listed above:

```
<queue>
    <name>com.unisys.jerm.queue.client.MySpecialAuditQueue</name>
    <minThreads>16</minThreads>
    <maxThreads>32</maxThreads>
    <addTimeout>200</addTimeout>
    </queue>
</chain>
```

Consequently, in accordance with this example, the XML code for the entire client-side work chain would look as follows:

```
<?xml version=“1.0” encoding=“UTF-8” ?>
<production>
    <!-- unique name to identify this production server -->
    <identification>
        <name>Prod1</name>
    </identification>
    <!-- information describing where the JERM Management
    server is -->
    <bindings>
        <serverAddress>localhost</serverAddress>
        <serverPort>9090</serverPort>
    </bindings>
    <!-- min/max number of threads to perform network io -->
    <workers>
        <min>10</min>
        <max>20</max>
    </workers>
    <!-- min/max number of connections in the connection pool-->
    <connections>
        <min>32</min>
        <max>64</max>
        <refill>16</refill>
    </connections>
    <!--
        name = class to instantiate
        minThreads = minimum number of workers threads
        to service queue
        maxThreads = maximum number of workers threads
        to service queue
        addTimeout = maximum time in ms to wait before timing
        out trying to
            produce to the queue
        -->
    <chain>
        <queue>
            <name>com.unisys.jerm.queue.client.
            SerializerQueue</name>
            <minThreads>16</minThreads>
            <maxThreads>32</maxThreads>
            <addTimeout>200</addTimeout>
        </queue>
        <queue>
            <name>com.unisys.jerm.queue.client.
            MySpecialAuditQueue</name>
            <minThreads>16</minThreads>
            <maxThreads>32</maxThreads>
            <addTimeout>200</addTimeout>
        </queue>
  </chain>
</production>
```

Likewise, the rules builder program 350 can be easily modified by a user, e.g., using the UI 410. This enables a user to easily make changes to the JERM rules manager program 330. Additionally, the entire behavior of the JERM rules server 310 can be modified by simply modifying XML code of the server-side work chain. Such ability enhances flexibility, ease of use, and scalability.

For example, an archiver computer software program (not shown) could be added to the JERM management server 310 to perform archiving tasks, i.e., logging of metrics data. To accomplish this, a <queue> fragment similar to the audit <queue> fragment that was added above to the client-side work chain is added to the server-side work chain at a location in the work chain following the rules manager code represented by block 330 in FIG. 2. As with the audit <queue> fragment added above, the archiver <queue> fragment will have a namespace, minimum (minThreads) and maximum (MaxThreads) thread limits, and a timeout period (addTimeout) limit. The Min and Max thread limits describe how many worker threads are to be allocated to the <queue> fragment service. The addTimeout limit describes the time period in milliseconds (ms) that the server 310 will wait before it stops trying to add to a full work queue. If for some reason it is later decided that the archiver <queue> fragment or another <queue> fragment is no longer needed, the <queue> fragment can easily be removed by the user via, for example, the user interface 410. For example, if the JERM system 200 is only intended to monitor, gather, and archive metrics data, the <queue> fragments of the portion of the server-side work chain corresponding to the JERM rules manager program 330 may be removed. This feature allows the vendor that provides the JERM system 200 to the enterprise customer to add functionality to the JERM system 200 by shipping one or more additional modules that plug into the client-side work chain, the server-side work chain, or both. Furthermore, the addition of the module or module does not affect any of the core code of the JERM system 200, but allows the customer to design and implement its own custom modules for its specific business needs.

The combination of all of these features makes the JERM system 200 a superior RMS over known RMSs in that the JERM system 200 has improved scalability, improved flexibility, improved response time, improved metrics monitoring granularity, and improved action taking ability over what is possible with known RMSs. As indicated above, the JERM system 200 is capable of monitoring, gathering, and acting upon both timing metrics and call metrics, which, as described above, is generally not possible with existing RMSs. As described above, existing RMSs tend to only monitor, gather, and act upon either timing metrics or call metrics. In addition, existing RMSs that monitor, gather, and act upon call metrics generally do not operate in real-time because doing so would adversely affect the performance of the application program that is performing a given transaction. By contrast, not only is the JERM system 200 capable of monitoring, gathering, and acting upon timing metrics and call metrics, but it is capable of doing so in real-time, or near real-time.

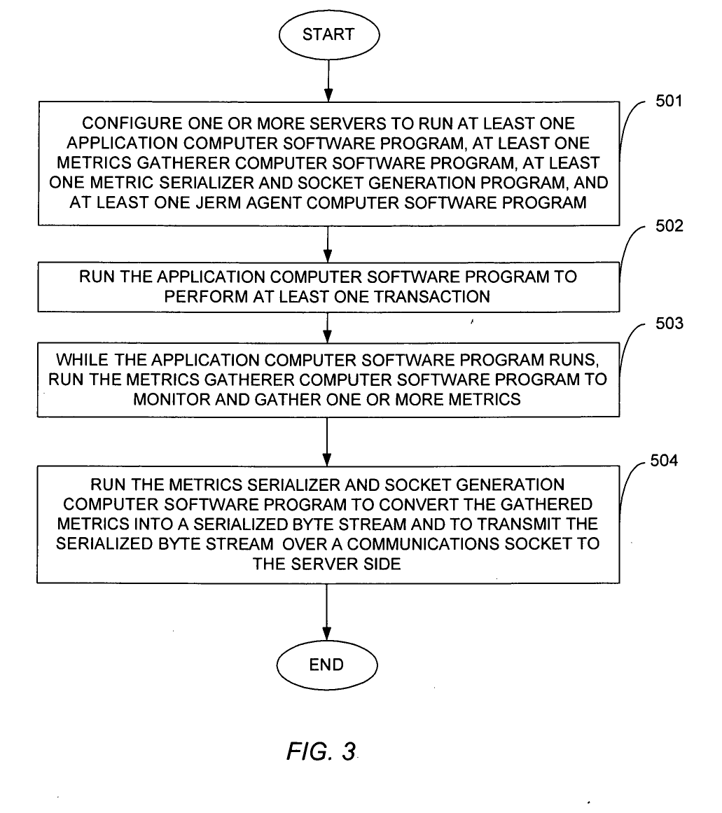

FIG. 3 is a flowchart that illustrates a method in accordance with an illustrative embodiment for performing Java enterprise resource management on the client side. On the client side, a server is configured to run at least one application computer software program, at least one metrics gatherer computer software program, at least one metrics serializer and socket generator computer software program, and at least one JERM agent computer software program, as indicated by block 501. The application program is run to perform at least one transaction, as indicated by block 502. While the application program runs, the metrics gatherer program monitors and gathers one or more metrics relating to the transaction being performed, as indicated by block 503. The metric serializer and socket generator program converts the gathered metrics into a serial byte stream and transmits the serial byte stream via a socket communications link to the server side, as indicated by block 504.

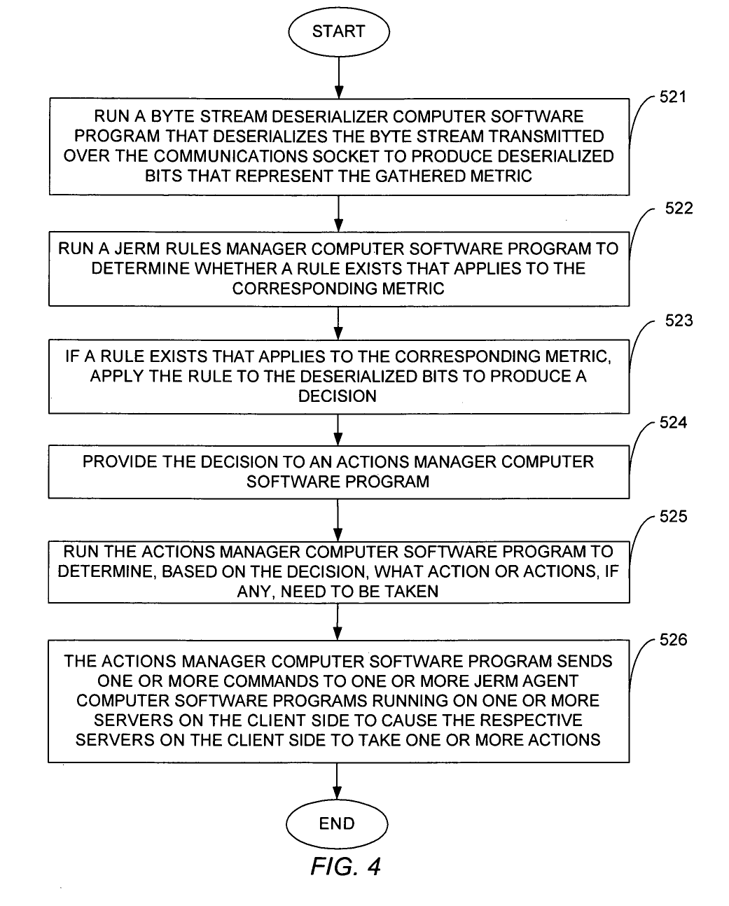

FIG. 4 is a flowchart that illustrates a method in accordance with an illustrative embodiment for performing Java enterprise resource management on the server side. On the server side, a byte stream deserializer program receives the serial byte stream and performs a deserializer algorithm that deserializes the serial byte stream to produce deserialized bits that represent the gathered metric, as indicated by block 521. A JERM rules manager program analyzes the deserialized bits to determine whether a rule exists that applies to the corresponding metric, as indicated by block 522. If the JERM rules manager program determines that an applicable rule does exist, the JERM rules manager program applies the rule to the deserialized bits and produces a decision, as indicated by block 523. The decision is then provided to an actions manager program, as indicated by block 524. The actions manager program then determines, based on the decision provided to it, one or more actions that are to be taken, if any, as indicated by block 525. The actions manager program then sends one or more commands to one or more JERM agent programs running on one or more servers on the client side instructing the JERM agent programs to cause their respective servers to perform the corresponding action or actions, as indicated by block 526.

As indicated above with reference to FIGS. 1 and 2, the actions may include scaling out one or more physical and/or virtual instances or scaling in one or more physical and/or virtual instances. The actions may also include re-purposing or re-allocation of a physical resource. The disclosed system and method are not limited with respect to the types of physical instances that may be scaled out, scaled in, re-purposed or re-allocated. An example of a physical instance is a server. A virtual instance may include, without limitation, an application computer software program, a JVM, or the like. The disclosed system and method are not limited with respect to the types of virtual instances that may be scaled out or scaled in. Virtual instances generally are not re-purposed or re-allocated, although that does not mean that the JERM system could not re-purpose or re-allocate virtual instances should a need arise to do so.

As described above with reference to FIGS. 1-4, the client Production Server and the JERM Management Server are configured to run a variety of computer software programs. These programs and any data associated with them are typically stored on some type of computer-readable medium (CRM), which may be internal to or external to the servers. The servers have CPUs or other processing devices that execute the instructions stored on the CRM when the software programs run on the CPUs or other processing devices. The disclosed system and method are not limited with respect to the type of CRM that is used for this purpose. For example, a CRM may be a random access memory (RAM) device, a read-only memory (ROM) device, a programmable ROM (PROM) device, an erasable PROM (EPROM) device, a flash memory device, a magnetic storage device, an optical storage device, or other type of memory device. Similarly, the disclosed system and method are not limited with respect to the type of CPU or processing device that is used to execute the various computer software programs. For example, the CPU or other processing device, referred to hereinafter as simply “processing device”, is typically one or more microprocessors, but may be, for example, a microcontroller, a special purpose application specific integrated circuit (ASIC), a programmable logic array (PLA), a programmable gate array (PGA), or any combination of one or more of such processing devices.

It should be noted that the disclosed system and method have been described with reference to illustrative embodiments to demonstrate principles and concepts, and features that may be advantageous in some embodiments. The disclosed system and method are not intended to be limited to these embodiments, as will be understood by persons of ordinary skill in the art in view of the description provided herein. A variety of modifications can be made to the embodiments described herein, and all such modifications are within the scope of the instant disclosure, as will be understood by persons of ordinary skill in the art.

What is claimed is:

1. A Java enterprise resource management (JERM) system for managing resources of an enterprise, the JERM system comprising:
at least a first input/output (I/O) communications port configured to function as a server-side end of a first communications socket to receive a first serial byte stream output from a second end of the communications socket via an I/O port of a production server located on a client side of the network, the first byte stream including information relating to at least a first metric that has been monitored and gathered by a production server located on a client side of the network during performance of one or more transactions by the production server; and
one or more processing devices, said one or more processing devices being configured to analyze the byte stream output from the second end of the communications socket to decide whether at least a first rule is to be applied to said at least a first metric, wherein if a decision is made that at least a first rule is to be applied to said at least a first metric, said one or more processing devices decide whether said at least a first metric is in compliance with said at least a first rule and produces a decision regarding compliance, and wherein said one or more processing devices analyze the decision regarding compliance and make a decision as to whether at least one physical instance, at least one virtual instance, or a combination of one or more physical and virtual instances needs to be scaled out or scaled in on the client side.

2. The JERM system of claim 1, wherein said first I/O communications port and said one or more processing devices are components of a JERM management server located on the server side of the network.

3. The JERM system of claim 2, wherein said one or more processing devices of the JERM management server is configured to run at least a first byte stream deserializer computer software program, at least a first rules management computer software program, and at least a first actions manager computer software program, wherein the first byte stream deserializer computer software program deserializes the first byte stream output from the second end of the communications socket to produce a deserialized byte stream, the deserialized byte stream corresponding to said at least a first metric, and wherein the first rules management program analyzes the deserialized byte stream and makes a decision as to whether at least a first rule is to be applied to said at least a first metric, and if so, decides whether said at least a first metric is in compliance with said at least a first rule and produces a decision regarding compliance, and wherein the actions manager program analyzes the decision regarding compliance and makes a decision as to whether at least one physical instance, at least one virtual instance, or a combination of one or more physical and virtual instances needs to be scaled out or scaled in on the client side.

4. The JEMR system of claim 3, wherein if the first actions manager program decides that at least one physical instance, at least one virtual instance, or a combination of one or more physical and virtual instances needs to be scaled out or scaled in on the client side of the network, the JERM management server causes at least one physical instance, at least one virtual instance, or a combination of one or more physical and virtual instances to be scaled out or scaled in on the client side of the network.

5. The JERM management system of claim 4, wherein the first rules management computer software program is a combination of computer software programs including at least a rules applier computer software program, a rules builder computer software program, and a rules manager proxy computer software program, wherein the rules applier program makes the decisions as to whether at least a first rule is to be applied to said at least a first metric, and if so, whether the deserialized byte stream is in compliance with the rule, and wherein the rules builder program comprises a rules database comprising rules that are used by the rules applier program to decide whether an applicable rule exists and whether the deserialized byte stream is in compliance with an applicable rule, and wherein the rules database is accessible via a user interface to allow a user to add, change or remove one or more of the rules, and wherein the rules manager proxy program sends the decision regarding compliance in a form of a web services call to the first actions manager program.

6. The JERM system of claim 5, wherein the first actions manager program is a combination of computer software programs including an action decider computer software program and an instance manager computer software program, wherein the action decider program receives the decision as to whether the deserialized byte stream is in compliance with the rule from the first rules management program and makes a decision as to whether an action needs to be taken by the first actions manager program, and wherein if the action decider program decides that an action needs to be taken, the instance manager program causes at least one physical instance, at least one virtual instance, or a combination of one or more physical and virtual instances to be scaled in or scaled out on the client side.

7. The JERM system of claim 4, said at least a first metric includes one or more of at least one of a central processing unit (CPU) utilization metric, a random access memory (RAM) device usage metric, a disk I/O performance metric, and a network I/O performance metrics.

8. The JERM system of claim 4, wherein said at least a first metric includes one or more of a response time metric, a Structured Query Language (SQL) calls metric, and an Enterprise JavaBeans (EJB) calls metric.

9. The JERM system of claim 4, wherein said at least a first metric includes one or more timing metrics and one or more call metrics, the one or more timing metrics including at least one or more of a central processing unit (CPU) utilization metric, a random access memory (RAM) device usage metric, a disk I/O performance metric, and a network I/O performance metrics, and wherein the one or more call metrics include one or more of at least a response time metric, a Structured Query Language (SQL) calls metric, and an Enterprise JavaBeans (EJB) calls metric.

10. The JERM system of claim 1, wherein the first communications socket is a Transmission Control Protocol/Internet Protocol (TCP/IP) socket.

11. The JERM system of claim 3, wherein the first byte stream deserializer program is a Java MBean computer software program.

12. The JERM system of claim 11, wherein at least the first byte stream deserializer program and the first rules management program are implemented in Extensible Markup Language (XML) code comprising a server-side work chain that can be modified in XML.

13. A Java enterprise resource management (JERM) method comprising:
at a server-side end of a communications socket, receiving a serial byte stream communicated over a communications socket from a client-side end of the communications socket to the server-side end of the communications socket, the serial byte stream including at least a first metric monitored and gathered by a production server located on a client side of a network during performance of one or more transactions by the production server;
in one or more processing devices located on the server side of the network, deserializing the serial byte stream received at the server-side end of the communications socket;
in said one or more processing devices, analyzing the deserialized byte stream to decide whether at least a first rule is to be applied to said at least a first metric;
in said one or more processing devices, if a decision is made that at least a first rule is to be applied to said at least a first metric, deciding whether said at least a first metric is in compliance with said at least a first rule and producing a decision regarding compliance; and
in said one or more processing devices, analyzing the decision regarding compliance and making a decision as to whether at least one physical instance, at least one virtual instance, or a combination of one or more physical and virtual instances needs to be scaled out or scaled in on the client side.

14. The JERM method of claim 13, wherein said first I/O communications port and said one or more processing devices are components of a JERM management server located on the server side of the network.

15. The JERM method of claim 14, wherein said one or more processing devices of the JERM management server is configured to run at least a first byte stream deserializer computer software program, at least a first rules management computer software program, and at least a first actions manager computer software program, wherein the first byte stream deserializer computer software program deserializes the first byte stream output from the second end of the communications socket to produce a deserialized byte stream, the deserialized byte stream corresponding to said at least a first metric, and wherein the first rules management program analyzes the deserialized byte stream and makes a decision as to whether at least a first rule is to be applied to said at least a first metric, and if so, decides whether said at least a first metric is in compliance with said at least a first rule and produces a decision regarding compliance, and wherein the actions manager program analyzes the decision regarding compliance and makes a decision as to whether at least one physical instance, at least one virtual instance, or a combination of one or more physical and virtual instances needs to be scaled out or scaled in on the client side.

16. The JEMR method of claim 15, wherein if the first actions manager program decides that at least one physical instance, at least one virtual instance, or a combination of one or more physical and virtual instances needs to be scaled out or scaled in on the client side of the network, the JERM management server causes at least one physical instance, at least one virtual instance, or a combination of one or more physical and virtual instances to be scaled out or scaled in on the client side of the network.

17. The JERM method of claim 15, wherein the first rules management computer software program is a combination of computer software programs including at least a rules applier computer software program, a rules builder computer software program, and a rules manager proxy computer software program, wherein the rules applier program makes the decisions as to whether at least a first rule is to be applied to said at least a first metric, and if so, whether the deserialized byte stream is in compliance with the rule, and wherein the rules builder program comprises a rules database comprising rules that are used by the rules applier program to decide whether an applicable rule exists and whether the deserialized byte stream is in compliance with an applicable rule, and wherein the rules database is accessible via a user interface to allow a user to add, change or remove one or more of the rules, and wherein the rules manager proxy program sends the decision regarding compliance in a form of a web services call to the first actions manager program.

18. The JERM method of claim 16, wherein the first actions manager program is a combination of computer software programs including an action decider computer software program and an instance manager computer software program, wherein the action decider program receives the decision as to whether the deserialized byte stream is in compliance with the rule from the first rules management program and makes a decision as to whether an action needs to be taken by the first actions manager program, and wherein if the action decider program decides that an action needs to be taken, the instance manager program causes at least one physical instance, at least one virtual instance, or a combination of one or more physical and virtual instances to be scaled in or scaled out on the client side.

19. The JERM method of claim 13, said at least a first metric includes one or more of at least one of a central processing unit (CPU) utilization metric, a random access memory (RAM) device usage metric, a disk I/O performance metric, and a network I/O performance metrics.

20. The JERM method of claim 13, wherein said at least a first metric includes one or more of a response time metric, a Structured Query Language (SQL) calls metric, and an Enterprise JavaBeans (EJB) calls metric.

21. The JERM method of claim 13, wherein said at least a first metric includes one or more timing metrics and one or more call metrics, the one or more timing metrics including at least one or more of a central processing unit (CPU) utilization metric, a random access memory (RAM) device usage metric, a disk I/O performance metric, and a network I/O performance metrics, and wherein the one or more call metrics include one or more of at least a response time metric, a Structured Query Language (SQL) calls metric, and an Enterprise JavaBeans (EJB) calls metric.

22. The JERM method of claim 13, wherein the first communications socket is a Transmission Control Protocol/Internet Protocol (TCP/IP) socket.

23. The JERM method of claim 15, wherein the first byte stream deserializer program is a Java MBean computer software program.

24. The JERM method of claim 15, wherein at least the first byte stream deserializer program and the first rules management program are implemented in Extensible Markup Language (XML) code comprising a server-side work chain that can be modified in XML.

25. A computer-readable medium (CRM) having instructions stored thereon for performing a Java enterprise resource management (JERM) method on a server side of a network, the instructions that are stored on the CRM comprising:
at least a first deserializer computer code portion, wherein when the first deserializer computer code portion runs on a JERM management server located on the server side of the network, the first deserializer computer code portion receives a serial byte stream corresponding to at least a first metric communicated over a communications socket from a production server located on a client side of the network and deserializes the received byte stream to produce a deserialized byte stream containing information relating to said at least a first metric, said at least a first metric corresponding to one or more metrics monitored and gathered by the production server while a transaction is performed by the production server;
at least a first rules management computer code portion, wherein when the first rules management computer code portion runs on the JERM management server, the first rules management computer code portion decides whether a rule exists that is associated with said at least a first metric, wherein if the first rules management computer code portion decides that an associated rule exists, the first rules management computer code portion applies the associated rule to the deserialized byte stream and produces a decision as to whether said at least a first metric is in compliance with the associated rule; and
at least a first actions manager computer code portion, wherein when the first actions manager computer code portion runs on the JERM management server, the first actions manager computer code portion determines, based on the decision as to whether said at least a first metric is in compliance with an associated rule, whether at least one action needs to be taken, wherein if the first actions manager computer code portion determines that at least one action needs to be taken, the first actions manager computer code portion causes one or more commands to be sent to the client side of the network to cause one or more production servers located on the client side of the network to perform one or more tasks consistent with said one or more commands.

26. The CRM of claim 25, wherein said one or more tasks performed by the said one or more production servers result in a scaling out or a scaling in on the client side of one or more physical instances, one or more virtual instances, or a combination of one or more physical and virtual instances.

27. The CRM of claim 26, wherein a physical instance includes a server, and wherein a virtual instance includes a Java application computer software program.
